(19) United States
(12) Patent Application Publication
(10) Pub. No.: US 2026/0204157 A1
(43) Pub. Date: Jul. 16, 2026

(54) SYSTEMS AND METHODS FOR SECURING A VEHICLE

(71) Applicant: Ford Global Technologies, LLC, Dearborn, MI (US)

(72) Inventors: Ryan O'Gorman, Beverly Hills, MI (US); Stuart C. Salter, White Lake, MI (US); Krishna Bandi, Novi, MI (US); Brendan Diamond, Naples, FL (US); Mario Anthony Santillo, Canton, MI (US); Vyas Darshan Shenoy, Canton, MI (US)

(73) Assignee: Ford Global Technologies, LLC, Dearborn, MI (US)

(21) Appl. No.: 19/018,835

(22) Filed: Jan. 13, 2025

(51) Int. Cl. G08G 1/0965; B60R 16/03; B60R 25/102; G06Q 30/0283; G06Q 50/40

(52) U.S. Cl. CPC G08G 1/0965; B60R 25/102; G06Q 50/40

(57) ABSTRACT

A method includes the assignment of a parking zone within a marshaling environment to each vehicle of a plurality of vehicles within a distance-related threshold from the marshaling environment, the selection of a first set of vehicles and a second set of vehicles of the plurality of vehicles within the parking zone, and causing the first set of vehicles to form a security wall that encompasses a perimeter surrounding the second set of vehicles.

### FIELD

The present disclosure relates to securing a vehicle within a parking setting, and more particularly, securing the vehicle by forming a security wall around the vehicle.

### BACKGROUND

The statements in this section merely provide background information related to the present disclosure and may not constitute prior art.

Vehicles marshaled within an inventory or a depot parking setting are typically unsecured and exposed to public access. Technology used in attempts to mitigate security issues includes vehicle sensing of an unauthorized person and, based on sensing the unauthorized person causing the vehicle to perform actions such as sound exciters, video, lights, or notifying authorities of the unauthorized person. However, this type of vehicle sensing requires the vehicle sensing-related systems to be active at all times, which, if the vehicle is a part of a group of vehicles, can be redundant and inefficient.

The present disclosure addresses these and other issues related to securing a vehicle within a parking setting.

### SUMMARY

This section provides a general summary of the disclosure and is not a comprehensive disclosure of its full scope or all of its features.

The present disclosure provides a method comprising: assigning, by an infrastructure system, a parking zone within a marshaling environment to each vehicle of a plurality of vehicles within a distance-related threshold from the marshaling environment; selecting a first set of vehicles and a second set of vehicles of the plurality of vehicles within the parking zone based on one or more security-based characteristics associated with each vehicle of the plurality of vehicles; and causing the first set of vehicles to form a security wall that encompasses a perimeter surrounding the second set of vehicles; wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof; further comprising: assigning a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof; wherein the one or more security-based characteristics includes historical data associated with one or more security threats of each vehicle of the plurality of vehicles, an expected departure time of each vehicle of the plurality of vehicles from the parking zone, or a combination thereof; wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof; further comprising: causing each vehicle of the second set of vehicles to enter a low energy consumption state; causing one or more sensors of each vehicle of the first set of vehicles to activate, wherein the activated one or more sensors are disposed on an exterior surface of each vehicle of the first set of vehicles farthest away from the second set of vehicles; and causing, in response to a violation of the security wall, each vehicle of the first set of vehicles to activate one or more security measures, transmit a wakeup signal to each vehicle of the second set of vehicles, or a combination thereof; and further comprising: causing one or more vehicles of the second set of vehicles to switch positions with one or more vehicles of the first set of vehicles based on a charge level of the one or more vehicles of the first set of vehicles.

The present disclosure provides a system comprising: an infrastructure system configured to: assign a parking zone within a marshaling environment to each vehicle of a plurality of vehicles within a distance-related threshold from the marshaling environment, select a first set of vehicles and a second set of vehicles of the plurality of vehicles within the parking zone based on historical data associated with one or more security threats of each vehicle of the plurality of vehicles and an expected departure time of each vehicle of the plurality of vehicles from the parking zone, and cause the first set of vehicles to form a security wall that encompasses a perimeter surrounding the second set of vehicles; and the first set of vehicles configured to: receive, from the infrastructure system, one or more marshaling commands, and proceed to form the security wall in response to receiving the one or more marshaling commands; wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof; wherein the infrastructure system is further configured to: assign a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof; wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof; wherein the infrastructure system is further configured to: cause each vehicle of the second set of vehicles to enter a low energy consumption state; cause one or more sensors of each vehicle of the first set of vehicles to activate, wherein the activated one or more sensors are disposed on an exterior surface of each vehicle of the first set of vehicles farthest away from the second set of vehicles; and cause, in response to a violation of the security wall, each vehicle of the first set of vehicles to activate one or more security measures, transmit a wakeup signal to each vehicle of the second set of vehicles, or a combination thereof; and wherein the infrastructure system is further configured to: cause one or more vehicles of the second set of vehicles to switch positions with one or more vehicles of the first set of vehicles based on a charge level of the one or more vehicles of the first set of vehicles.

The present disclosure provides one or more non-transitory computer-readable media storing processor-executable instructions that, when executed by at least one processor, cause the at least one processor to: assign a parking zone within a marshaling environment to each vehicle of a plurality of vehicles within a distance-related threshold from the marshaling environment; select a first set of vehicles and a second set of vehicles of the plurality of vehicles within the parking zone based on one or more security-based characteristics associated with each vehicle of the plurality of vehicles; and cause the first set of vehicles to form a security wall that encompasses a perimeter surrounding the second set of vehicles; wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof; wherein the at least one processor is further caused to: assign a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof; wherein the one or more security-based characteristics includes historical data associated with one or more security threats of each vehicle of the plurality of vehicles, an expected departure time of each vehicle of the plurality of vehicles from the parking zone, or a combination thereof; wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof; wherein the at least one processor is further caused to: cause each vehicle of the second set of vehicles to enter a low energy consumption state; cause one or more sensors of each vehicle of the first set of vehicles to activate, wherein the activated one or more sensors are disposed on an exterior surface of each vehicle of the first set of vehicles farthest away from the second set of vehicles; and cause, in response to a violation of the security wall, each vehicle of the first set of vehicles to activate one or more security measures, transmit a wakeup signal to each vehicle of the second set of vehicles, or a combination thereof; and wherein the at least one processor is further caused to: cause one or more vehicles of the second set of vehicles to switch positions with one or more vehicles of the first set of vehicles based on a charge level of the one or more vehicles of the first set of vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIGS. 3A-3C is a process flow diagram illustrating an example method for securing a vehicle in accordance with one or more embodiments of the present disclosure;

FIG. 4 is an example system for securing the vehicle in accordance with one or more embodiments of the present disclosure;

FIG. 5 is a flowchart illustrating an example method for securing a vehicle in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for securing one or more vehicles by creating a security barrier (e.g., a security wall) formed of vehicles to surround other vehicles to protect a group of vehicles positioned within the interior of the security barrier by surrounding the protected group of vehicles. In one or more examples, the presently described formation of the security barrier provides one or more advantages over other methods that may use vehicles as a perimeter to outline an entirety of a parking lot to prevent vehicles from being vandalized or stolen. Example advantages include, but are not limited to, an implementation of several perimeters forming the security barrier within a parking lot for multiple purposes (e.g., long term storage, high value vehicle protection, variable number of vehicles necessary for containment, etc.); a dynamically adaptable security barrier that reinforces itself based on application, which can change many times in a day; and a means to allow support for various access and use cases (e.g., restricted access, vehicle or pedestrian access, time of day access, etc.).

In one or more examples, the presently described formation of the security barrier can reduce data and energy use based on monitoring for potential security threats compared to other systems (e.g., systems that require all vehicles to maintain active security surveillance features at all times). In some examples, an adaptive perimeter of vehicles is used so that the number of vehicles for security monitoring is optimized based on the group of vehicles to be protected (e.g., requirements for protecting the vehicles) rather than simply outlining or surrounding the entirety of the parking lot, which thereby reduces the number of vehicles needed to be actively monitoring for potential security threats. In some examples, given the vehicle orientation and proximity of the vehicles included in the security barrier as described herein, only exterior-facing sensors of the vehicles included in the security barrier need to be used for monitoring for potential security threats, which reduces energy usage and data usage. In some examples, one or more vehicles included in the security barrier can enter a sleep state or mode as described herein to further save energy and data usage.

In one or more examples, the presently described formation of the security barrier preserves a vehicle battery in instances of long term storage of a vehicle resulting from the dynamic security barrier as is described herein. As a particular example, because the security barrier can switch vehicles based on battery usage for other vehicles, a charge and/or robustness of vehicle batteries can be preserved instead of constantly using the vehicle batteries associated with only the vehicles included within the security barrier.

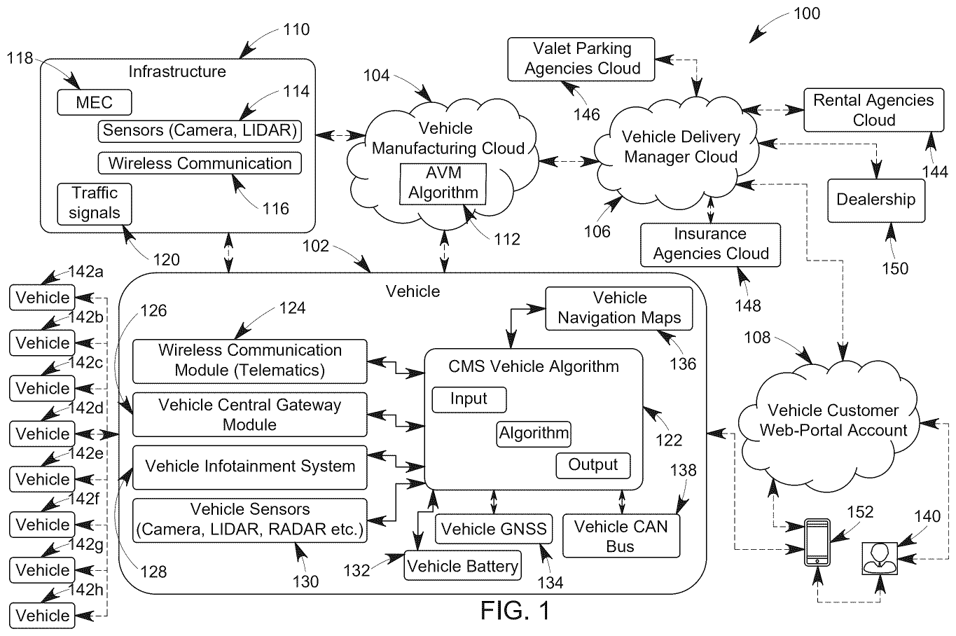

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

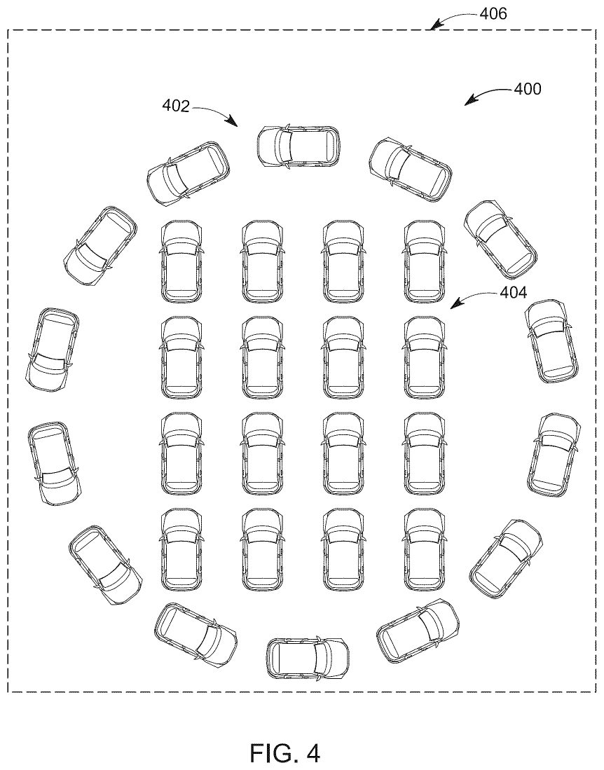

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment (e.g., a marshaling environment 406 as shown in FIG. 4). For example, the marshaling environment 406 can represent a parking setting as described herein. As another example, the marshaling environment 406 can also represent a plant marshaling setting, an automated charging setting, or a depot marshaling setting, among others. As an example, the plant marshaling setting can include an instance wherein just-built vehicles are moved through end-of-line testing at a vehicle assembly plant via overhead vision sensing (e.g., one or more sensors 114). As another example, the plant marshaling setting can also include an instance wherein vehicles are caused to move (e.g., marshaled) through the vehicle assembly plant (e.g., from a workstation to another workstation) via the overhead vision sensing. As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the parking setting can include an instance wherein vehicles are moved through various parking settings such as, but not limited to, underground or covered parking environments.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop (e.g., park), or pause progression through the marshaling environment 406. The vehicle manufacturing cloud system 104 is further configured to control a marshaling speed of the one or more vehicles as the one or more vehicles travel through (e.g., traverse) the marshaling environment 406. For example, the vehicle manufacturing cloud system 104 utilizes the infrastructure-side AVM algorithm 112 to send instructions to the vehicle 102 and/or to process information received from the vehicle 102.

The infrastructure system 110 includes the one or more sensors 114, a wireless communication component 116, a multi-access edge computing (MEC) system 118, and one or more traffic signals 120. It is understood that the MEC system 118 is configured to support communication between the wireless communication component 116 and the vehicle 102. It is understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the one or more sensors 114 that are configured to manage and/or include, for example, one or more of cameras, lidar, radar, and/or ultrasonic devices. The one or more sensors 114 monitors the movement of the one or more vehicles as the vehicle(s) are marshaled through the marshaling environment 406. Additionally, the wireless communication component 116 is also in communication with the traffic signals 120. For example, the wireless communication component 116 may cause the traffic signals 120 to direct traffic of the one or more vehicles as the one or more vehicles are marshaled through the marshaling environment 406. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits an object (e.g., a wall or another vehicle) and is then reflected back to the vehicle 102. Based on the amount of time it takes for the sound wave to return to the vehicle 102, the vehicle 102 can determine the distance between the one or more vehicle sensors 130 and the object. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the object and is then reflected back to the vehicle 102. Based on the amount of time it takes for the electromagnetic waves to return to the vehicle 102, the vehicle 102 can determine a range, velocity, and angle of the vehicle 102 relative to the object.

The one or more vehicle sensors 130 are also utilized to perform an inspection or monitoring of another vehicle, for example and as is discussed herein and in relation to securing the other vehicle. The one or more vehicle sensors 130 communicate information associated with the position and/or distance at which the vehicle 102 is relative to the object to the vehicle-side AVM algorithm 122. The one or more vehicle sensors 130 also communicate information associated with the inspection or monitoring to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142a-142h. The vehicle 102 is also configured to communicate (e.g., forward) any instructions received from the infrastructure system 110 and/or the vehicle manufacturing cloud system 104 to any of the one or more additional vehicles 142a-142h. For example, the communication of the vehicle 102 with the one or more additional vehicles 142a-142h can aid the infrastructure system 110 and/or the vehicle manufacturing cloud system 104 in marshaling the one or more additional vehicles 142a-142h and/or securing the one or more additional vehicles 142a-142h. As another example, the one or more additional vehicles 142a-142h are configured to also inspect or monitor the vehicle 102. However, it is understood that any of the one or more additional vehicles 142a-142h or the vehicle 102 are configured to be able to inspect or monitor any other vehicle.

It is understood that each of the one or more additional vehicles 142a-142h can include any of the components described as being included within the vehicle 102, such as the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142a-142h are configured to communicate information associated with any of the components included therein with the vehicle 102. It is further understood that the one or more additional vehicles 142a-142h can also be configured to establish a direct line of wireless communication (e.g., via a communication link) with the infrastructure system 110 and/or the vehicle manufacturing cloud system 104, whereby information can be directly exchanged between the one or more additional vehicles 142a-142h and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

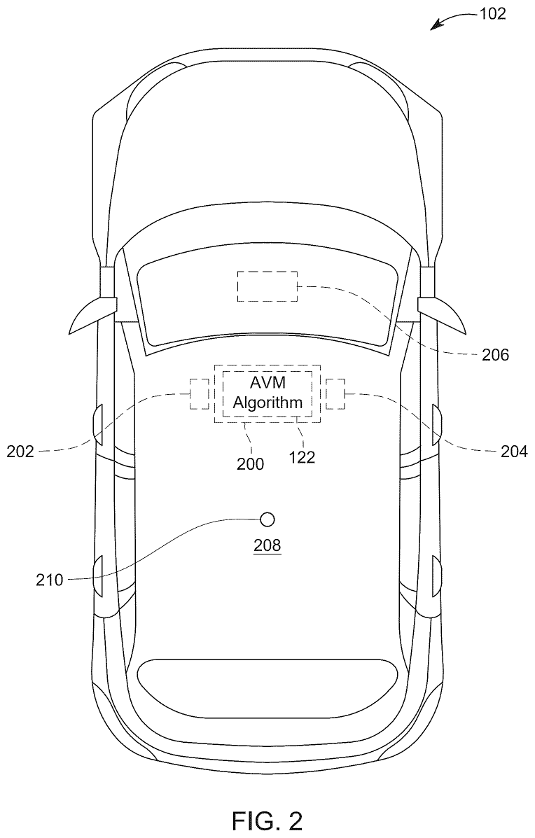

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between such devices represented by the vehicle controller 200 in this disclosure. Further, as discussed below, various other controllers and/or sensors provide data to the vehicle controller 200 via the vehicle communication network.

In addition, the vehicle controller 200, via a vehicle-side AVM algorithm 122, is configured for communicating through a vehicle-to-infrastructure communication network, such as communicating with an infrastructure controller (not shown). The vehicle controller 200, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), Including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, individuals, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc. It is understood that the entirety of the description associated with the vehicle 102 is applicable to each vehicle of the one or more vehicles 142a-142h.

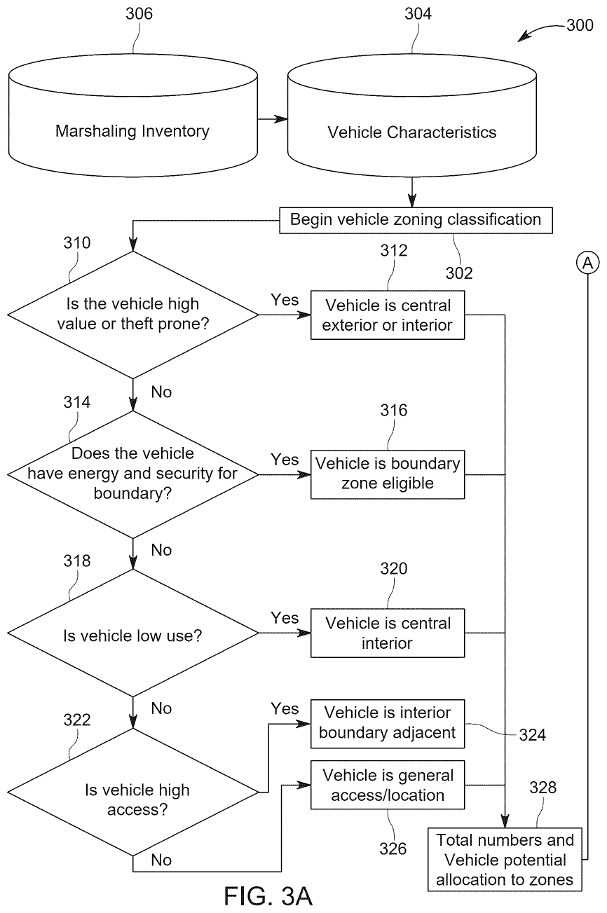

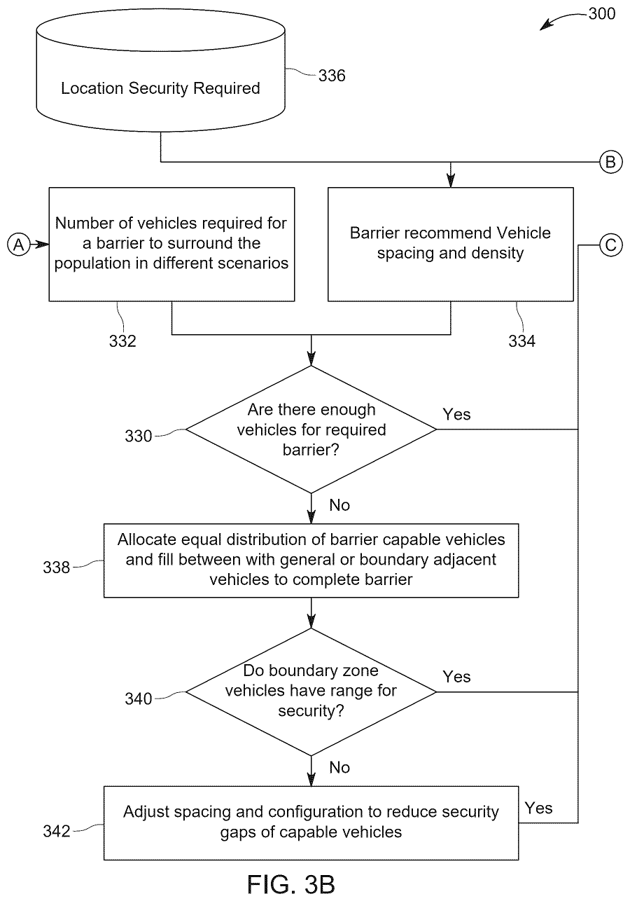

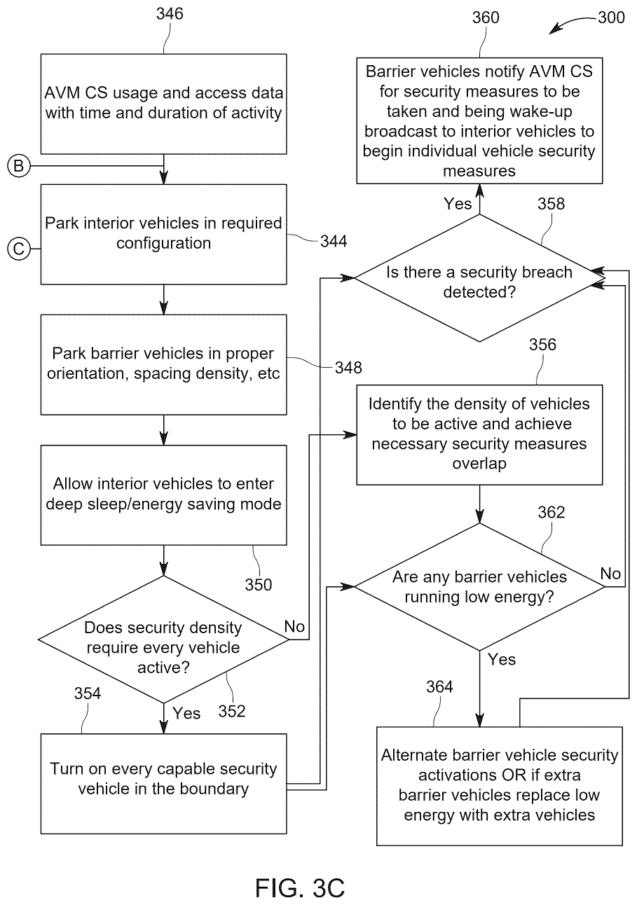

FIGS. 3A-3C illustrate steps 300 used to create a security wall (e.g., a security wall 402 or security boundary as shown in FIG. 4) as described herein. It is understood that while the security wall 402 is illustrated as a circle, the security wall 402 can be formed corresponding to any shape. In one or more embodiments, a vehicle zoning classification is initiated at step 302 based on one or more vehicle characteristics and/or a marshaling inventory. It is understood, however, that the initiation of the vehicle zoning classification can be based on any consideration associated with the marshaling of a vehicle (e.g., the vehicle 102) and/or the vehicle itself. In one or more examples, the one or more vehicle characteristics are stored in a first database 304 and the marshaling inventory is stored in a second database 306. It is understood that each of the first database 304 and the second database 306 can be positioned internally within an infrastructure system (e.g., the infrastructure system 110) itself or externally positioned in relation to the infrastructure system. However, it is also understood that both of the one or more vehicle characteristics and the marshaling inventory can be stored in the same database. In one or more examples, the initiation of the vehicle zoning classification is performed by a processor and/or a cloud system associated with the infrastructure system. As another example, the one or more vehicle characteristics can include a vehicle type associated with the vehicle, a sensor suite capability of the vehicle, a value of the vehicle, an energy capacity of the vehicle, or a combination thereof among others. As yet another example, the marshaling inventory can include information associated with the marshaling of the vehicle such as a time of day, a location of a parking zone (e.g., the parking zone 400 as shown in FIG. 4), an expected departure time of the vehicle from the parking zone 400, one or more operations the vehicle is expected to perform within the parking zone 400, one or more inspections expected to be performed on the vehicle within the parking zone 400, or a combination thereof.

In one or more embodiments, the infrastructure system may rely on one or more neural network(s) installed within the infrastructure-side AVM algorithm 112 to make one or more determinations associated with the creation of the security wall 402 as described herein and through the utilization of one or more deep learning techniques.

As an example, the infrastructure-side AVM algorithm 112 is configured to determine whether a value of the vehicle meets or exceeds a predefined value and/or whether the vehicle is prone to theft at step 310. As another example, the determination of whether the value of the vehicle meets or exceeds a predefined value and/or whether the vehicle is prone to theft can be based on the zoning classification associated with the vehicle. For example, the predefined value can be based on a dollar amount or any other basis that can correspond to the value of the vehicle. As another example, whether the vehicle is prone to theft can be based on historical data related to past cases of theft that can be updated in real-time and stored within either of the first database 304 and/or the second database 306. As a further example, and in a case wherein the infrastructure-side AVM algorithm 112 determines that the value of the vehicle meets or exceeds the predefined value and/or that the vehicle is prone to theft, the vehicle is categorized (at step 312) as being optimally positioned within an interior of the parking zone 400 (e.g., as part of a group of protected vehicles 404 as shown in FIG. 4).

However, in a case wherein the infrastructure-side AVM algorithm 112 determines that the value of the vehicle does not meet or exceed the predefined value and/or that the vehicle is not prone to theft, the infrastructure-side AVM algorithm 112 is configured to determine whether the vehicle is equipped with certain security features and has sufficient energy to be positioned within the security wall 402 at step 314. As an example, the security features can include, but is not limited to, an alarm system, window sensors, door lock actuators, immobilizers, or a combination thereof among others. As another example, a threshold associated with an energy level can be predefined and correspond to any range of energy levels determined to be sufficient for a vehicle to be included within the security wall 402. As yet another example, the threshold associated with the energy level can be based on, but is not limited to, an amount of time the security wall 402 is going to be active for or a charging speed of each vehicle of the one or more vehicles. In one or more examples, the threshold can be based on a charging speed of a vehicle included as part of the group of protected vehicles 404 so that the infrastructure-side AVM algorithm 112 can determine at which point the vehicle included as part of the group of protected vehicles 404 and the vehicle included within the security wall 402 can switch positions. In other words, when the energy level of the vehicle included within the security wall 402 falls below the threshold energy level and the energy level of the vehicle included as part of the group of protected vehicles 404 meets or exceeds the threshold energy level, the vehicle included within the security wall 402 and the vehicle included as part of the group of protected vehicles 404 can switch positions, for example.

As an example, and in a case wherein the infrastructure-side AVM algorithm 112 determines that the vehicle is equipped with certain security features and has sufficient energy to be positioned within the security wall 402, the vehicle is identified (at step 316) as eligible to be positioned within a boundary (e.g., the security wall 402). However, in a case wherein the infrastructure-side AVM algorithm 112 determines that the vehicle is not equipped with certain security features and/or does not have sufficient energy to be positioned within the security wall 402, the infrastructure-side AVM algorithm 112 is configured to determine whether the vehicle is a low-use vehicle at step 318. As an example, the vehicle can be considered to be a low-use vehicle in a case wherein the vehicle has a low-energy level (e.g., below the threshold energy level), lacks certain security features that would cause the vehicle to be considered eligible to be positioned within the security wall 402, or a combination thereof, among others.

As a further example, and in a case wherein the infrastructure-side AVM algorithm 112 determines that the vehicle is a low-use vehicle, the vehicle is categorized (at step 320) as being a vehicle included as part of the group of protected vehicles 404. However, in a case wherein the infrastructure-side AVM algorithm 112 determines that the vehicle is not a low-use vehicle, the infrastructure-side AVM algorithm 112 is configured to determine whether the vehicle is a high access vehicle at step 322. As an example, the vehicle can be considered to be a high access vehicle based on an expected departure time of the vehicle from the parking zone 400, one or more operations the vehicle is expected to perform within the parking zone 400, one or more inspections expected to be performed on the vehicle within the parking zone 400, or a combination thereof.

In a case wherein the infrastructure-side AVM algorithm 112 determines that the vehicle is a high access vehicle, the vehicle is understood (at step 324) to be included as part of the group of protected vehicles 404 and adjacent to the security wall 402. However, in a case wherein the infrastructure-side AVM algorithm 112 determines that the vehicle is not a high access vehicle, the vehicle is understood (at step 326) as being a general access vehicle positioned anywhere interior to the security wall 402 as part of the group of protected vehicles 404.

It is understood that the infrastructure-side AVM algorithm 112 is configured to make each of the determinations described herein and that correspond to each of the steps 310, 314, 318, and 322 for each vehicle of the one or more vehicles. Further, the infrastructure-side AVM algorithm 112 is also configured to calculate (at step 328) a total number of vehicles to be allocated within the parking zone 400. It is also understood that the determination of the total number of vehicles to be allocated within the parking zone 400 can be based on each of the steps 312, 316, 320, 324, and 326.

The infrastructure-side AVM algorithm 112 is further configured to determine whether there are enough vehicles to create a sufficient security wall at step 330. In one or more examples, the sufficiency of the security wall 402 is defined (at step 332) based on a number of vehicles required to form a security wall (e.g., the security wall 402) that will encompass the remaining vehicles of the one or more vehicles (e.g., entirely surround the group of protected vehicles 404) in different scenarios. As an example, the number of vehicles required to form the security wall 402 that will encompass the remaining vehicles of the one or more vehicles in different scenarios can be based on the calculation of the total number of vehicles to be allocated within the parking zone 400. As another example, the different scenarios can correspond to different formations of the security wall 402 that can include, but is not limited to, a single-walled security wall, a double-walled security wall, a tight-walled security wall, a loosely-spaced security wall, among others.

In one or more examples, the sufficiency of the security wall 402 is also defined (at step 334) based on a recommended vehicle spacing and/or density associated with a formation of the security wall 402. As an example, the recommendation defining the vehicle spacing and/or the density associated with the formation of the security wall 402 can be based on required security associated with a particular location such as the parking zone 400. In one or more examples, information associated with the security requirements associated with the particular location is stored in a third database 336. It is understood that the third database 336 can be positioned internally within the infrastructure system itself or externally positioned in relation to the infrastructure system. However, it is understood that the information associated with the security requirements associated with the particular location can be stored in the same database as that which may store the one or more vehicle characteristics and the marshaling inventory. As an example, the recommendation defining the vehicle spacing and/or the density associated with the formation of the security wall 402 can include, but is not limited to, a single-walled security wall, a double-walled security wall, spacing and/or tightness within the single-walled security wall or the double-walled security wall, among others.

In a case wherein the infrastructure-side AVM algorithm 112 determines that there are not enough vehicles to create a sufficient security wall, the infrastructure-side AVM algorithm 112 is configured to equally distribute barrier-eligible vehicle(s) at step 338. Also, at step 338, the infrastructure-side AVM algorithm 112 is also configured to position one or more vehicle(s) that have not been identified as barrier-eligible between the barrier-eligible vehicles within the security wall 402. In one or more examples, the inclusion of the one or more vehicle(s) that have not been identified as barrier-eligible within the security wall 402 allows for the security wall 402 to be complete (e.g., fill in gaps within the security wall 402).

The infrastructure-side AVM algorithm 112 is further configured to determine whether the barrier-eligible vehicle(s) within the security wall 402 has a sufficient range associated with the one or more security features at step 340. In one or more examples, the sufficiency of the range can include, but is not limited to, a communication-related range associated with the barrier-eligible vehicle(s) within the security wall 402 and the infrastructure system. As another example, the sufficiency of the range can be defined based on a range-related threshold. For example, the range-related threshold can correspond to a signal strength that is predefined as adequate to support a functionality of the security features associated with the barrier-eligible vehicle(s) within the security wall 402.

In a case wherein the infrastructure-side AVM algorithm 112 determines that the barrier-eligible vehicle(s) within the security wall 402 does not have a sufficient range associated with the one or more security features, the infrastructure-side AVM algorithm 112 is configured to adjust the spacing between each of the barrier-eligible vehicle(s) within the security wall 402 and the one or more vehicle(s) that have not been identified as barrier-eligible within the security wall 402 at step 342. In one or more examples, by adjusting the spacing between each of the barrier-eligible vehicle(s) within the security wall 402 and the one or more vehicle(s) that have not been identified as barrier-eligible within the security wall 402, the infrastructure-side AVM algorithm 112 effectively reduces any security gaps (e.g., physical gaps between vehicles) within the security wall 402.

In one or more embodiments, the group of protected vehicles 404 are parked within a particular configuration at step 344. For example, the particular configuration can include, but is not limited to, varying spacing between each vehicle of the group of protected vehicles 404. As another example, the spacing between each vehicle of the group of protected vehicles 404 can be less in an instance wherein the group of protected vehicles 404 are parked overnight. In another example, the spacing between each vehicle of the group of protected vehicles 404 can be more in an instance wherein the group of protected vehicles 404 require access for service, inspection(s), or any other reason. However, it is understood that the spacing between each vehicle of the group of protected vehicles 404 can vary by any degree and for any reason.

In one or more examples, parking each vehicle of the group of protected vehicles 404 within a particular configuration can be based on an identification (at step 346) of a usage of the infrastructure-side AVM algorithm 112, a timing of when data is accessed, a duration of an activity, or a combination thereof among others. It is understood that the usage of the infrastructure-side AVM algorithm 122, the timing of when data is accessed, and/or the duration of the activity is individually associated with each vehicle of the group of protected vehicles 404. In one or more examples, parking each vehicle of the group of protected vehicles 404 within a particular configuration can also be based on the information associated with the security requirements corresponding to the particular location stored in the third database 336.

The infrastructure-side AVM algorithm 112 is configured to cause the barrier-eligible vehicle(s) to be positioned (e.g., parked) within the security wall 402 at step 348. In one or more examples, the infrastructure-side AVM algorithm 112 is configured to cause the barrier-eligible vehicle(s) to be positioned within the security wall 402 through a vehicle marshaling means. As another example, the infrastructure-side AVM algorithm is configured to cause the barrier-eligible vehicle(s) to be positioned within the security wall 402 based on a particular orientation and/or spacing density in consideration of other barrier-eligible vehicles positioned within the security wall 402.

The infrastructure-side AVM algorithm 112 is also configured to cause the barrier-eligible vehicle(s) positioned within the security wall 402 (at step 350) to allow the group of protected vehicles 404 to enter a deep sleep mode or an energy saving mode while the security wall 402 encompasses (e.g., protects) the group of protected vehicles 404.

In one or more embodiments, the infrastructure-side AVM algorithm 112 is further configured to determine whether every vehicle included in the security wall 402 is required to be active (at step 352) based on a spacing density of the security wall 402. In a case wherein a determination is made that every vehicle included in the security wall 402 is required to be active, the infrastructure-AVM algorithm 112 is configured to cause each vehicle included in the security wall 402 to turn on at step 354. However, in a case wherein a determination is made that every vehicle included in the security wall 402 is not required to be active, the infrastructure-AVM algorithm 112 is configured to identify (at step 356) a number of vehicles included in the security wall 402 that is required to be active and a required level of overlapping that pertains to a plurality of security measures. A predefined security density in combination with an activation of one or more security features is a non-limiting example of overlapping security measures.

In one or more embodiments, the infrastructure-side AVM algorithm 112 is configured to determine whether a security breach is detected at step 358. In one or more examples, a determination of whether a security breach is detected is performed in an instance wherein each vehicle included in the security wall 402 is caused to turn on. In an instance wherein a determination is made that a security breach is detected, the barrier-eligible vehicle(s) is configured to notify the infrastructure-side AVM algorithm 112 of one or more security measures that should be taken to mitigate the detected security breach at step 360. For example, the one or more security measures can be a broadcasted wake-up signal transmitted to each vehicle of the protected vehicles 404. As another example, the broadcasted wake-up signal can cause each vehicle of the protected vehicles 404 to initiate individual security measures.

In one or more embodiments, the infrastructure-side AVM algorithm 112 is also configured to determine whether any of the vehicles included in the security wall 402 is running on low-energy at step 362. In one or more examples, a determination of whether any of the vehicles included in the security wall 402 is running on low-energy is performed in an instance wherein each vehicle included in the security wall 402 is caused to turn on. In an instance wherein at least one vehicle of the vehicles included in the security wall 402 are determined to be running on low-energy, one or more alternate security activations can be initiated (at step 364) in relation to any of the vehicles included in the security wall. For example, the one or more alternate security activations can include, but are not limited to, switching the security features of one vehicle off in exchange for switching the security features of another vehicle on. Alternatively, and in an instance wherein at least one vehicle of the vehicles included in the security wall 402 are determined to be running on low-energy, any of the vehicles included in the security wall 402 can be replaced with any other vehicle, such as any vehicle of the group of protected vehicles 404 at step 364. In one or more embodiments, it is understood that the infrastructure-side AVM algorithm 112 uses either result provided at step 364 as a basis for determining whether a security breach is detected at step 358. Further, and in an instance wherein none of the vehicles included in the security wall 402 are determined to be running on low-energy, the infrastructure-side AVM algorithm 112 is configured to determine whether a security breach is detected at step 358.

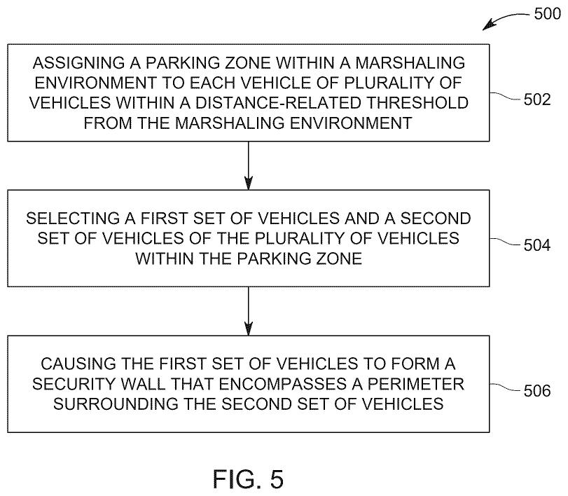

FIG. 5 is a flowchart illustrating an example method 500 for creating a security wall (e.g., the security wall 402) as described herein. At operation 502, an infrastructure system (e.g., the infrastructure system 110) is configured to assign a parking zone (e.g., the parking zone 400) within a marshaling environment (e.g., the marshaling environment 406) to each vehicle (e.g., the vehicle 102) of a plurality of vehicles within a distance-related threshold from the marshaling environment. As an example, the distance-related threshold can represent any predefined range of distances that can correspond to the vehicle arriving within a communication range from the infrastructure system. As another example, the assignment of the parking zone within the marshaling environment can be assigned to each vehicle of the plurality of vehicles as each vehicle of the plurality of vehicles enters a parking facility or a marshaling environment. In one or more examples, the assignment of the parking zone to each vehicle of the plurality of vehicles is based on a duration of time each vehicle of the plurality of vehicles will be parked in the parking zone (e.g., how long each vehicle of the plurality of vehicles will stay in the parking zone without an expected movement), a powertrain architecture of each vehicle of the plurality of vehicles (e.g., how long each vehicle of the plurality of vehicles can parked without needing to be driven, how much energy each vehicle of the plurality of vehicles expends performing one or more security monitoring tasks/operations, or how long each vehicle of the plurality of vehicles expends performing one or more security monitoring tasks/operations), a value of each vehicle of the plurality of vehicles, historical data associated with one or more security threats (e.g., or vandalism) of each vehicle of the plurality of vehicles, a sensing capability (e.g., or level of security) of each vehicle of the plurality of vehicles, or a combination thereof.

At operation 504, the infrastructure system is also configured to select a first set of vehicles (e.g., vehicles included within the security wall 402) and a second set of vehicles (e.g., vehicles included within the group of protected vehicles 404) of the plurality of vehicles within the parking zone. In one or more examples, the selection of the first set of vehicles and the second set of vehicles of the plurality of vehicles within the parking zone is based on one or more security-based characteristics associated with each vehicle of the plurality of vehicles. As another example, the first set of vehicles is selected based on a vehicle type of each vehicle of the plurality of vehicles, a sensor suite capability of each vehicle of the plurality of vehicles, a value of each vehicle of the plurality of vehicles, or a combination thereof. As an additional example, the one or more security-based characteristics includes historical data associated with one or more security threats of each vehicle of the plurality of vehicles, an expected departure time of each vehicle of the plurality of vehicles from the parking zone, or a combination thereof.

At operation 506, the infrastructure system is further configured to cause the first set of vehicles to form a security wall that encompasses a perimeter surrounding the second set of vehicles. In one or more examples, the security wall is formed once a total number of vehicles to be parked in the parking zone is defined. For example, the formation of the security wall can include a calculation of a required spacing between each vehicle of the first set of vehicles as well as a number of vehicles necessary to form the security wall that would fully encompass the perimeter that would surround the second set of vehicles. As an example, the level of security required to protect the second set of vehicles can be based on historical data corresponding to historic theft and/or vandalism associated with the parking zone. As yet another example, the security wall can either be a sparse wall or provide full wall monitoring. In one or more embodiments, the sparse wall performs monitoring activities and allows for the entry/exit of vehicles and/or people through the security wall. As an example, the sparse wall is used in cases where vehicles are expected to move out of the parking zone, or the parking zone is in a low risk marshaling environment. As another example, the sparse wall can be used based on different levels of vehicle monitoring density as well as operational needs of each of the vehicles. In one or more embodiments, the full wall monitoring can provide a single or double wall perimeter around the second set of vehicles. As an example, spacing between the first set of vehicles in an instance wherein the full wall monitoring is used can prevent vehicles and/or people from breaching the security wall.

In one or more embodiments, the infrastructure system is additionally configured to assign a parking orientation and/or spacing to each vehicle of the plurality of vehicles based on a number of vehicles within the parking zone (e.g., which is determined based on expected vehicle influxes and/or parking capacity associated with the parking zone), a time of day (e.g., that is prone to theft and/or vandalism), a location of the parking zone (e.g., that is prone to theft and/or vandalism), an expected departure date and/or time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof. As an example, the assignment of the parking orientation and/or spacing to each vehicle of the plurality of vehicles is to provide accessible space to each vehicle of the plurality of vehicles in consideration of one or more operational activities as described herein. It is understood that the assignment of the parking orientation and/or spacing to each vehicle of the plurality of vehicles can vary. For example, the spacing between each of the vehicles parked within the parking zone can be tighter in consideration of overnight protection and looser during normal operations when vehicles need to be accessible as described herein. As an additional example, vehicles that require access (e.g., in consideration of a repair and/or an inspection) or are expected to enter or exit the parking zone can be parked towards the edge of the security wall to allow for easier access to those particular vehicles.

In one or more embodiments, the infrastructure system is configured to cause each vehicle of the second set of vehicles to enter a low energy consumption state (e.g. to save energy and/or data flows). As an example, the low energy consumption state can cause to consume a lesser amount of energy while still being in an operating state or a monitoring state. As another example, the low energy consumption state can be, but is not limited to, a sleep mode or a standby mode. The infrastructure system is also configured to cause one or more sensors of each vehicle of the first set of vehicles to activate. For example, the activated one or more sensors are disposed on an exterior surface of each vehicle of the first set of vehicles farthest away from the second set of vehicles. For example, by activating only the one or more sensors disposed on the outside of the security wall, general energy usage expended by the first set of vehicles is reduced. As another example, each vehicle of the first set of vehicles is configured to operate in synchronization, which allows for some vehicles within the security wall to enter a low energy consumption state and wake up in an instance wherein a threat is detected by vehicles in the security wall that remained awake. As yet another example, the sleeping vehicles are caused to wake up by receiving at least one wakeup signal either directly or through a cloud system so each sleeping vehicle can perform any preprogrammed actions to mitigate the security threat. In response to a violation of the security wall, the infrastructure system is further configured to cause each vehicle of the first set of vehicles to activate one or more security measures, transmit a wakeup signal to each vehicle of the second set of vehicles, or a combination thereof.

In one or more embodiments, the first set of vehicles is configured to permit access to the second set of vehicles based on one or more access procedures that can be based on, but not limited to, an identity of a requestor. For example, the first set of vehicles is configured to provide access to the second set of vehicles to the requestor by moving in unison or causing an individual vehicle from the first set of vehicles to reposition itself. As another example, the provided access can be based on a size of the requestor such as a vehicle or a person, which would result in varying movements of the first set of vehicles to provide adequate space for the requestor to enter through the security wall. The first set of vehicles is also configured to close the spacing opened for the requestor based on any timing to reform the security wall. In one or more embodiments, the infrastructure system is configured to cause one or more vehicles of the second set of vehicles to switch positions with one or more vehicles of the first set of vehicles based on a charge level of the one or more vehicles of the first set of vehicles.

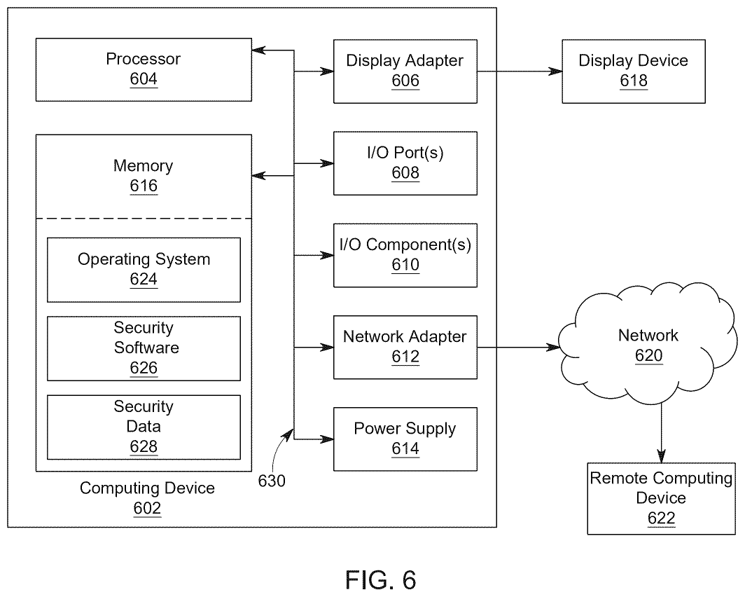

FIG. 6 illustrates an operating environment, such as a computer system, that facilitates the performance of one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, RAM, or a combination thereof. The memory 616 is configured to provide storage for instructions and data associated with the operation of the computing device 602. The memory 616 can generally include an operating system 624, security software 626, and security data 628 to perform one or more operations described in more detail herein. For example, the operating system 624 is configured to manage and/or process any of the data and/or instructions associated with the security software 626 and/or the security data 628, as described in more detail herein.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provide a means for forming a security wall around a vehicle or a group of vehicles through the utilization of one or more methods and systems described herein that can employ the use of one or more machine learning techniques and/or other processing or control techniques, wherein the security wall is formed around the vehicle or group of vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.” In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A method comprising:
assigning, by an infrastructure system, a parking zone within a marshaling environment to each vehicle of a plurality of vehicles within a distance-related threshold from the marshaling environment;
selecting a first set of vehicles and a second set of vehicles of the plurality of vehicles within the parking zone based on one or more security-based characteristics associated with each vehicle of the plurality of vehicles;
causing the first set of vehicles to form a security wall that encompasses a perimeter entirely surrounding the second set of vehicles; and
determining, by the infrastructure system, whether there are enough vehicles of the first set of vehicles to form the security wall and in response to determining that there are not enough vehicles of the first set of vehicles to form the security wall, distributing the first set of vehicles and positioning one or more vehicles that have not been identified as part of the first set of vehicles between the first set of vehicles within the security wall.

2. The method of claim 1, wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof.

3. The method of claim 1, further comprising:
assigning a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof.

4. The method of claim 1, wherein the one or more security-based characteristics includes historical data associated with one or more security threats of each vehicle of the plurality of vehicles, an expected departure time of each vehicle of the plurality of vehicles from the parking zone, or a combination thereof.

5. The method of claim 1, wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof.

6. The method of claim 1, further comprising:
causing each vehicle of the second set of vehicles to enter a low energy consumption state;
causing one or more sensors of each vehicle of the first set of vehicles to activate, wherein the activated one or more sensors are disposed on an exterior surface of each vehicle of the first set of vehicles farthest away from the second set of vehicles; and
causing, in response to a violation of the security wall, each vehicle of the first set of vehicles to activate one or more security measures, transmit a wakeup signal to each vehicle of the second set of vehicles, or a combination thereof.

7. The method of claim 1, further comprising:
causing one or more vehicles of the second set of vehicles to switch positions with one or more vehicles of the first set of vehicles based on a charge level of the one or more vehicles of the first set of vehicles.

8. A system comprising:
an infrastructure system configured to:
assign a parking zone within a marshaling environment to each vehicle of a plurality of vehicles within a distance-related threshold from the marshaling environment,
select a first set of vehicles and a second set of vehicles of the plurality of vehicles within the parking zone based on historical data associated with one or more security threats of each vehicle of the plurality of vehicles and an expected departure time of each vehicle of the plurality of vehicles from the parking zone, and
cause the first set of vehicles to form a security wall that encompasses a perimeter entirely surrounding the second set of vehicles;
determine whether there are enough vehicles of the first set of vehicles to form the security wall, and in response to determining that there are not enough vehicles of the first set of vehicles to form the security wall, distribute the first set of vehicles and position one or more vehicles that have not been identified as part of the first set of vehicles between the first set of vehicles within the security wall; and
the first set of vehicles configured to:
receive, from the infrastructure system, one or more marshaling commands, and
proceed to form the security wall in response to receiving the one or more marshaling commands.

9. The system of claim 8, wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof.

10. The system of claim 8, wherein the infrastructure system is further configured to:
assign a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof.

11. The system of claim 8, wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof.

12. The system of claim 8, wherein the infrastructure system is further configured to:
cause each vehicle of the second set of vehicles to enter a low energy consumption state;
cause one or more sensors of each vehicle of the first set of vehicles to activate, wherein the activated one or more sensors are disposed on an exterior surface of each vehicle of the first set of vehicles farthest away from the second set of vehicles; and
cause, in response to a violation of the security wall, each vehicle of the first set of vehicles to activate one or more security measures, transmit a wakeup signal to each vehicle of the second set of vehicles, or a combination thereof.

13. The system of claim 8, wherein the infrastructure system is further configured to:
cause one or more vehicles of the second set of vehicles to switch positions with one or more vehicles of the first set of vehicles based on a charge level of the one or more vehicles of the first set of vehicles.

14. One or more non-transitory computer-readable media storing processor-executable instructions that, when executed by at least one processor, cause the at least one processor to:
assign a parking zone within a marshaling environment to each vehicle of a plurality of vehicles within a distance-related threshold from the marshaling environment;
select a first set of vehicles and a second set of vehicles of the plurality of vehicles within the parking zone based on one or more security-based characteristics associated with each vehicle of the plurality of vehicles;
cause the first set of vehicles to form a security wall that encompasses a perimeter entirely surrounding the second set of vehicles; and
determine whether there are enough vehicles of the first set of vehicles to form the security wall in response to determining that there are not enough vehicles of the first set of vehicles to form the security wall, distribute the first set of vehicles and position one or more vehicles that have not been identified as part of the first set of vehicles between the first set of vehicles within the security wall.

15. The one or more non-transitory computer-readable media of claim 14, wherein the assignment of the parking zone to each vehicle of the plurality of vehicles is based on a duration of time each vehicle of the plurality of vehicles will be parked in the parking zone, a powertrain architecture of each vehicle of the plurality of vehicles, a value of each vehicle of the plurality of vehicles, historical data associated with one or more security threats of each vehicle of the plurality of vehicles, a sensing capability of each vehicle of the plurality of vehicles, or a combination thereof.

16. The one or more non-transitory computer-readable media of claim 14, wherein the at least one processor is further caused to:
assign a parking orientation and spacing to each vehicle of the plurality of vehicles based on a number of vehicles within the parking zone, a time of day, a location of the parking zone, an expected departure time of each vehicle of the plurality of vehicles from the parking zone, one or more operations each vehicle of the plurality of vehicles is expected to perform within the parking zone, one or more inspections expected to be performed on any of the vehicles of the plurality of vehicles within the parking zone, or a combination thereof.

17. The one or more non-transitory computer-readable media of claim 14, wherein the one or more security-based characteristics includes historical data associated with one or more security threats of each vehicle of the plurality of vehicles, an expected departure time of each vehicle of the plurality of vehicles from the parking zone, or a combination thereof.

18. The one or more non-transitory computer-readable media of claim 14, wherein the first set of vehicles is selected based on a vehicle type of each vehicle of the plurality of vehicles, a sensor suite capability of each vehicle of the plurality of vehicles, a value of each vehicle of the plurality of vehicles, or a combination thereof.

19. The one or more non-transitory computer-readable media of claim 14, wherein the at least one processor is further caused to:
cause each vehicle of the second set of vehicles to enter a low energy consumption state;
cause one or more sensors of each vehicle of the first set of vehicles to activate, wherein the activated one or more sensors are disposed on an exterior surface of each vehicle of the first set of vehicles farthest away from the second set of vehicles; and
cause, in response to a violation of the security wall, each vehicle of the first set of vehicles to activate one or more security measures, transmit a wakeup signal to each vehicle of the second set of vehicles, or a combination thereof.

20. The one or more non-transitory computer-readable media of claim 14, wherein the at least one processor is further caused to:
cause one or more vehicles of the second set of vehicles to switch positions with one or more vehicles of the first set of vehicles based on a charge level of the one or more vehicles of the first set of vehicles.
